(19) United States
(12) Patent Application Publication
(10) Pub. No.: US 2006/0166620 A1
(43) Pub. Date: Jul. 27, 2006

(54) Control system including an adaptive motion detector

(76) Inventor: Christopher Donald Sorensen, Risskov (DK)

Correspondence Address: CANTOR COLBURN, LLP, 55 GRIFFIN ROAD SOUTH, BLOOMFIELD, CT, 06002, US

(21) Appl. No.: 10/534,326

(22) PCT Filed: Nov. 7, 2002
(86) PCT No.: PCT/DK02/00749

§ 371 Date: Mar. 17, 2006

(51) Int. Cl. H04B 5/00

(52) U.S. Cl. 455/41.1

(57) ABSTRACT

The invention relates to a control system including control means and a user interface, the user interface including means for communication of control signals from a user to the control means, the user interface being adaptive. According to the invention the user may interact with the user interface and thereby establish signals to be communicated to the control means for further processing and subsequently be converted into a certain intended action.

### FIELD OF THE INVENTION

The present invention relates to a control system as stated in claim 1.

### BACKGROUND OF THE INVENTION

Several methods of communication are available within the prior art ranging from conventional interface means such as for instance keyboard, mouse and monitor of a computer to more advanced gesture reading or gesture activated systems.

Trivial examples of such systems may be the above-mentioned standard computer system comprising a standardized interface means, such as keyboard or mouse in conjunction with a monitor. Such known interface means have been modified in numerous different embodiments, in which a user, when desired, may input control signals to a computer-controlled data processing.

Other very simple examples to be mentioned are automatic door opening systems, automatically controlled lighting systems, video surveillance systems, etc. Such systems have at least one significant feature in common, i.e. that the trigger criterion basically is whether something or somebody is present within a trigger zone or not. The trigger zone is typically defined by the characteristics of the applied detectors.

A further example may be voice recognition triggered systems, typically adapted for detection of certain predefined voice commands.

A common and very significant feature of all the above-mentioned systems is that the user interface is predefined, i.e. the user must adapt to the available user interface. This feature may cause practical problems to a user when trying to adapt to the user interface in order to obtain the desired establishment of control signals.

This is in particular a problem when dealing with motion/movement triggered systems. This problem is even more annoying when dealing with more advanced detection means due to the fact that such detection means typically require carefully installation and adjustments prior to use.

It is the object of the invention to obtain a system and a method of establishing control signals having user-friendly properties, and where the system and method in particular relaxes the requirements to the user.

### SUMMARY OF THE INVENTION

The present invention relates to a control system comprising control means and a user interface, said user interface comprising means for communication of control signals from a user to said control means, said user interface being adaptive.

According to the invention the user may interact with the user interface and thereby establish signals communicated to the control means for further processing and subsequently be converted into a certain intended action.

By control means is understood any micro-processor, digital signal processor, logical circuit etc. with necessary associated circuits and devices, e.g. a computer, being able to receive signals, process them, and send them to one or more output media or subsequent control systems.

By user interface is understood one or more devices working together to interact with the user, by e.g. facilitating user inputs, sending feedback to the user, etc.

When, according to the invention, the user interface is adaptive, it is possible to change one or more parameters of the user interface. This may e.g. comprise changes according to having different users of the system, different input methods, manual or automatic calibration of different input methods, manual or automatic adjustment of the way the signals are sent to the control means, different output media or subsequent control systems, etc.

According to a preferred embodiment of the invention, the control system may be applied for establishment of control signals on the very initiative of the user and within an input framework defined by the user.

The fact that the user may establish the input framework facilitates a remarkable possibility of creating a communication from the user under the very control of the user and even more important, controlled by means of the user interface defined by the user. In other words, the user may predetermine the meaning of certain user available acts.

Again, in other words, the user interface may be adapted for communicating control signals from a user to a related application, which thereby becomes adapted to the individual abilities of the users. This is in particular advantageous to users having reduced communication skills when compared to the average skills due to fact that the input framework may be adapted to interpret the available user established acts instead of adapting the acts to the available input framework.

According to the invention, such interpretation of the available user established acts may be particularly advantageous when allowing the user to establish such acts partly or completely within the kinesphere, e.g. by means of gestures.

The associating of the user defined acts and the triggered control signals may be performed in several different ways depending on the application. One such application may for example be a remote control.

A remote control may, within the scope of the invention, be established as a set of user-established acts, which when performed, result in certain predefined incidents. The incidents may for example comprise different types of multimedia events of for instance specific interfaced actions. Multimedia events may for example include numerous typical multimedia user invoked events, such as programming of a TV, VCR, HiFi, etc, modification of audio settings, such as volume, treble or bas, modification of image settings, such as contrast, color, etc.

A remote control may then initially be programmed by a user by means of detectable acts, which may be performed by the user in a reproducible way. These may be regarded as a selection of trigger criteria by means of which a user may trigger desired events by means of suitable hardware. In this regard an advantageous feature should be highlighted: the fact that the trigger criteria may be different from user to user. This fact is extremely important when the users have different abilities to establish trigger criteria, which may be distinguished from each other.

Control signals may in this context be regarded as for example signals controlling a communication from for instance a user to the ambient world or for example control signals in a more conventional context, i.e. signals controlling a user controllable process, such as a computer.

In an embodiment of the invention, said user interface comprises motion detection means (MDM), output means (OM) and adaptation means (AM) adapted for receipt of motion detection signals (MDS) obtained by said motion detection means (MSM), establishing an interpretation frame on the basis of said motion detection signals (MDS) and establishing and outputting communication signals (CS) to said output means (OM) on the basis of said motion detection signals (MDS) and said interpretation frame.

According to a preferred embodiment of the invention, the establishment of an interpretation frame may be performed more or less automatically.

According to an embodiment of the invention, the user activates a calibration mode in which the user demonstrates the interpretation frame actively by performing the intended or available motions. Upon this calibration mode, the system may compare, on a runtime basis, the obtained detected motion invoked signals to the interpretation frame, and derive the associated communication signals. Such communication signals may for example be obtained as specific distinct commands or for example as running position coordinates.

According to the invention a more or less automatic interpretation frame may be established. This may for example be done by automatically applying the users initial motion invoked input as a good estimate of the interpretation frame. Moreover, this interpretation frame may in practice be adapted or optimized automatically during use by suitable analyzing of the obtained motion invoked signal history.

According to the invention, the term user should be understood quite broadly as the individual user of the system, but it may of course also include a helper, for example a teacher, a therapist or a parent.

In an embodiment of the invention, said user interface comprises signal processing means or communicates with motion detection means (MDM) determining the obtained signal differences by comparison with the signals obtained when establishing said interpretation frame.

According to the preferred embodiment the invention, relatively simple position determining algorithms may be applied due to the fact that the interpretation of detector signals is not locked once and for all when the system is delivered to the customer.

In an embodiment of the invention, said user interface is distributed.

According to this embodiment of the present invention, the different parts of the system do not need to be placed at the same physical place. The motion detection means MDM naturally have to be placed where the movements to be detected are performed, but the adaptation means AM and subsequent output means OM may as well be placed anywhere else, and be connected through e.g. wireless communication means, wires, the Internet, local area networks, telephone lines, etc. Data-relaying devices may be placed between the elements of the system to enable the transmission of data.

In an embodiment of the invention, said motion detection means MDM comprises a set of motion detection sensors (SEN1, SEN2 . . . SENn).

According to this embodiment of the invention, the system comprises a number of sensors for motion detection. A preferred embodiment of the invention comprises several sensors, not to say that necessarily all of them should be used simultaneously, but rather to present the user with a choice of possible sensors.

In an embodiment of the invention, said set of motion detection sensors (SEN1, SEN2 . . . SENn) are exchangeable.

According to an embodiment of the invention, the motion detection sensors may be exchangeable. This feature enables an advantageous possibility of optimizing the performance and the characteristics of the motion detector means.

In an embodiment of the invention, said set of motion detection sensors (SEN1, SEN2 . . . SENn) forms a motion detection means (MDM) combined by at least two motion detection sensors (SEN1, SEN2 . . . SENn) and where the individual motion detection sensor may be exchanged with another motion detection sensor.

According to the above mentioned embodiment the combined desired function of the motion detection means may be obtained by the user choosing a number of motion detection sensors suitable for the application. In other words, the user may in fact adapt the motion detection means to the application.

In an embodiment of the invention, said set of motion detection sensors (SEN1, SEN2 . . . SENn) comprises at least two different types of motion detection sensors.

The motion detection means may comprise different kinds of sensors detecting motions by means of different technologies. Such technologies may comprise detection with infrared light, laser light or ultrasound, CDC-based detection, comprising e.g. the use of digital cameras or video cameras, etc.

According to an embodiment of the invention, the user may benefit not only from a combined ability to detect certain motions obtained by geometrically distributing the detectors to cover the expected motion detection space. He may also obtain a combined measuring effect by combining different types of motion detection sensors, i.e. detection sensors having different measuring characteristics. Such different characteristics may include different abilities to obtain meaningful measures in a measuring space featuring undesired high contrasts, different angle covering, etc.

It may also be appreciated that the invention facilitates the possibility of optimizing the measuring means to the intended task.

In an embodiment of the invention, said motion detection means (MDM) may be optimized by a user to the intended purpose by exchanging or adding motion detection sensors (SEN1, SEN2, . . . SENn), preferably by means of at least two different types of motion detection sensors (SEN1, SEN2 . . . SENn).

According to an embodiment of the invention, a user or a person involved in the use of the system may optimize the system, preferably in the basis of very little knowledge about the technical performance of the individual detection sensors.

In an embodiment of the invention, said at least two different types of motion detection sensors (SEN1, SEN2 . . . SENn) are mutually distinguishable.

According to this very preferred embodiment of the invention, each kind of sensor is made distinctive from the other kinds. In a preferred embodiment of the invention, the sensors are designed in such a way that they may be used without any knowledge of their internal construction or the technology they use. Thus the user may not know which of the sensors are actually cameras, or which are infrared sensors, etc. Instead, according to this embodiment, the user may know the sensors from each other by their distinctions.

The distinctions may consist in different colors, shapes, sizes, plug shapes, labels, etc. With a preferred embodiment of the invention, a user may be given instructions or advices like this: “Place green sensors in each hand of the sensor stand, and a red sensor in the head.”, “Put a cylindrical sensor on each foot of the sensor stand.”, or “If you encounter detection problems with a blue sensor, then try to replace it with a yellow.”.

The user may additionally know the sensors on their qualities rather than their technology. Thus a wide optic camera device may be referred to as a sensor for broad movements or body movements, and may be assigned one color or shape, an infrared sensor may be referred to as a sensor for limb movements or movements towards and away from the sensor stand, and may be assigned a second color or shape, and a laser sensor device may be referred to as a sensor for precision measurements and be assigned a third color or shape.

Letting the user know the sensors by their qualities and visible distinctions rather than their technology makes the embodiment very advantageous. The system is then very flexible and easy to upgrade or change, as the manufacturer may change the specific implementation and construction of the different sensors, as long as he just maintains their visible distinctions, e.g. shape, and their specific quality, e.g. wide range. Moreover the system becomes very user-friendly, as the user does not need to know anything about how the system works, or what kind of technology is most suitable for specific movements. He just needs to know what qualities are associated with what sensor shapes or colors. Also the fact that shapes and colors are recognized and distinguished by most people, even children or persons suffering from different disabling handicaps, makes this embodiment superior to an embodiment requiring the user to know what an infrared sensor is, how to distinguish a camera from an ultrasound sensor or even be able to read the words.

In an embodiment of the invention, said user interface comprises remote control means.

According to this embodiment of the invention, a user, e.g. a therapist, may control various parameters of the adaptation means AM or the output means OM with a remote control. This is especially advantageous when the system is distributed, as the user may then be uncomfortably far away from the adaptation means or the output means.

The remote control means may be a common infrared remote control, or it may be more advanced hand held devices such as e.g. a portable digital assistant, known as a PDA, or other remote control apparatuses. The remote control means may communicate with either the motion detection means, the adaptation means or the output means. The communication link may be established by means of infrared light, e.g. the IrDA protocol, radio waves, e.g. the Bluetooth protocol, ultrasound or other means for transferring signals.

In an embodiment of the invention, said motion detection sensors (SEN) are driven by rechargeable batteries.

According to this very preferred embodiment of the invention, the sensors are equipped with rechargeable batteries. Thereby flexibility is obtained as the sensors do not need any wiring, and the possibility of recharging when not used makes sure that the batteries are never flat.

In an embodiment of the invention, said motion detection means (MDM) comprise a sensor tray (ST) for holding said motions detection sensors (SEN1, SEN2 . . . SENn).

According to this embodiment of the invention, a tray is provided for holding the sensors. This is beneficial when the system comprises several sensors, and only few of them are in use simultaneously. The unused ones may then be kept in the tray.

In an embodiment of the invention, said sensor tray (ST) comprises means for recharging said motion detection sensors (SEN1, SEN2 . . . SENn).

According to this very preferred embodiment of the invention, the sensors may be recharged while they are kept in the tray. Thereby is ensured that the sensors are ready to use when needed.

In an embodiment of the invention, said motion detection signals (MDS) are transmitted by means of wireless communication.

According to this very preferred embodiment of the invention, the sensors do not need to be wired to anything, as they may be driven by rechargeable means. This causes the system to be very user-friendly and flexible.

In an embodiment of the invention, said communication signals (CS) are transmitted by means of establishing wireless communication.

According to this very preferred embodiment of the invention, the adaptation means does not need to be wired to the output means, and thereby eases the use of the system, as well as expands the possibilities for connectivity with external devices used for output means.

In an embodiment of the invention, said wireless communication exploits the Bluetooth technology.

This embodiment of the invention comprises Bluetooth (trademark of Bluetooth SIG, Inc.) communication means implemented in the sensors and the adaptation means, or the adaptation means and the output means, or all three.

In an embodiment of the invention, said wireless communication exploits wireless network technology.

This embodiment of the invention comprises wireless network interfaces implemented in the sensors and the adaptation means, or the adaptation means and the output means, or all three. Wireless network technology comprises e.g. Wi-Fi (Wide Fidelity, trademark of Wireless Ethernet Compatibility Alliance) or other wireless network technologies.

In an embodiment of the invention, said wireless communication exploits wireless broadband technology.

This embodiment of the invention comprises wireless broadband communication means implemented in the sensors and the adaptation means, or the adaptation means and the output means, or all three.

In an embodiment of the invention, said wireless communication exploits UMTS technology.

This embodiment of the invention comprises UMTS (trademark of European Telecommunications Standards Institute, ETSI) interface means implemented in the sensors and the adaptation means, or the adaptation means and the output means, or all three.

In an embodiment of the invention, said control signals represent control commands.

According to this embodiment of the invention, said user interface is used to receive control commands from a user, and forward these to the control means.

This embodiment may e.g. be used to control machines, TV-sets, computers, video games, etc.

In an embodiment of the invention, said control signals represent information.

According to this embodiment of the invention, said user interface is used to receive information from a user, and forward this information to the control means.

This embodiment may e.g. be used to let a user send messages or requests or express his feelings. With this embodiment the control means may e.g. send the information to a second user by means of appropriate output means, such as e.g. loud speakers, text displays, etc., thereby letting the first user communicate with the second user.

In an embodiment of the invention, said user interface comprises motion detection means.

This embodiment of the invention facilitates the use of motions as input to the user interface. It is thereby possible to use the system without being able to speak, push buttons, move a mouse etc.

In an embodiment of the invention, said motion detection means are touch-less.

This is a very preferred embodiment of the invention, which enables the system to be positioned at a distance from the user. Thereby several advantages are achieved, e.g. letting the user assume the posture which fits him best or is best suited to what he is doing, letting the user position himself anywhere he wants and enabling the user to use small or big gestures according to his own wishes or needs to communicate with the user interface.

In an embodiment of the invention, said user interface comprises mapping means.

With this preferred embodiment of the invention, the user interface is able to map a specific motion or gesture to a specific signal to send to the control means.

The complexity of the motions or gestures is fully definable, and may depend on several parameters. The more complex the motions are, the more different motions may be recognizable by the mapping means. The simpler the motions are, the easier and faster they are to perform, and demands less concentration or other cognitive skills, and are thereby more suited for rehabilitational use of the invention.

Furthermore the motions to be used may be more or less directly derived from the end use of the system. If e.g. the system is used as a substitute for a common TV remote control, it is most useful if the mapping means is able to recognize at least the same number of gestures, as there are buttons on the substituted remote control. If, on the other hand, the system is used for rehabilitation of an injured leg, by letting the user control something by moving his leg, only the number of different movements which are useful for that rehabilitation purpose needs to be recognizable by the mapping means. If e.g. the system is used to control a character in a video game, which may only move from side to side of the screen, it is natural to map e.g. sideward movements of the body to sideward movement of the video character.

In an embodiment of the invention, said user interface comprises calibration means.

According to this preferred embodiment of the invention, it is possible to calibrate the user interface and its sensors, mapping means etc. to a specific use situation or a specific user. Thereby it is possible to use the same system for many purposes or with many different users. This is especially important when the system is used for rehabilitation.

In an embodiment of the invention, said control means comprise means for communicating said signals to at least one output medium.

According to this very preferred embodiment of the invention, the control means are able to deliver the control- or information signal from the user to one or more output media.

In an embodiment of the invention, said mapping means comprise predefined mapping tables.

By mapping tables are understood tables holding information of specific motions or gestures associated with specific control signals.

With this embodiment of the invention, the mapping tables are predefined, i.e. each control signal is associated with a motion.

In an embodiment of the invention, said mapping means comprise user-defined mapping tables.

With this preferred embodiment of the invention, the user is able to define the motions to associate with the control signals.

In an embodiment of the invention, said mapping means comprise at least two mapping tables.

According to this embodiment, it is possible for two or more users to have each their own mappings of motions and gestures.

In an embodiment of the invention, said mapping means comprise at least two mapping tables and a common control mapping table.

According to this embodiment, it is possible for two or more users to each have their own mappings of motions and gestures, and thereto a set of motions or gestures common to all users, to e.g. turn on the system, change user, choose mapping table, etc.

In an embodiment of the invention, said mapping means comprise motion learning means.

According to this embodiment, entries in the mapping tables may be filled in during use of the system, by asking the user to make the movement or gesture he or she wants to be associated with a certain control signal.

In an embodiment of the invention, said motion learning means comprise means for testing and validating new motions.

According to this embodiment, the learning means are able to test a new motion e.g. against already known motions or against the ability of the sensors, to prevent learning motions not distinguishable from already known motions, or not recognizable enough. When a new motion is discarded on this basis, the system may ask the user to choose another motion for that particular control signal.

In an embodiment of the invention, said motion detection means comprise at least one sensor.

In a preferred embodiment of the invention two or more sensors are used, but use of the system requiring only one sensor is perfectly imaginable.

In an embodiment of the invention, said at least one sensor is an infrared sensor.

In a very preferred embodiment of the invention, three infrared sensors are used. By “infrared sensor” is referred to any sensor able to detect any kind of motion by means of infrared light technologies. This comprise e.g. sensors with an infrared emitter and detector placed together, letting the detector measure possible reflections of the emitted light, or an infrared emitter and an infrared detector placed at each side of the subject, letting the detector detect the amount of infrared light reaching it.

Infrared sensors are especially well suited for long-range needs, i.e. when motions comprise moving towards or away from the sensors. Infrared sensors are also well suited to detect small gestures or motions.

In an embodiment of the invention, said at least one sensor is an optical sensor.

The term “optical sensor” is understood as any sensor able to detect any kind of motion by means of visible light technologies. This comprise e.g. sensors with a visible light emitter and detector, or different kinds of digital cameras or video cameras.

In an embodiment of the invention, said optical sensor is a CCD-based sensor.

In an embodiment of the invention, said optical sensor is a digital camera.

In an embodiment of the invention, said optical sensor is a digital video camera

In an embodiment of the invention, said optical sensor is a web camera.

For the above-mentioned CCD-based sensors, digital cameras, video cameras and web cameras apply that they are especially well suited for wide-range needs, i.e. when motions comprise moving sidewards in front of the sensor.

In an embodiment of the invention, said at least one sensor is an ultrasound sensor.

By ultrasound sensor is understood any sensor able to detect any kind of motion by means of ultrasound technologies, e.g. sensors comprising an ultrasound emitter and an ultrasound detector measuring the reflected amount of the emitted ultrasound.

In an embodiment of the invention, said at least one sensor is a laser sensor.

By laser sensor is understood any sensor able to detect any kind of motion by means of laser light technologies.

In an embodiment of the invention, said at least one sensor is an electromagnetic wave sensor.

By electromagnetic wave sensor is understood any sensor able to detect any kind of motion by means of electromagnetic waves. This comprises e.g. radar sensors, microwave sensors etc.

In an embodiment of the invention, said motion detection means comprise at least two different kinds of sensors.

This is a very preferred embodiment of the invention, which facilitates the use of different sensors with the same user interface. As the different sensors have different advantages, it is hereby possible to get the best from them all. In a preferred embodiment, the user does not need to know what kinds of sensors he is using, as the user interface he is interacting with does not change behavior with the kind of sensor that is used. The user may know however, which sensor is best suited for wide-range movements, long-range movements, small and precise gestures, etc.

In an embodiment of the invention, said at least two different kinds of sensors are used simultaneously.

This very preferred embodiment of the invention facilitates the use of e.g. two infrared sensors and a digital video camera at the same time, giving the user interface great possibilities of detecting and recognizing complex or advanced motions, or gestures almost identical. Furthermore the user interface may automatically select which of the attached sensors are best suited for the current kind of use, and then ignore possible other sensors, which may interfere with the calculations, or just contribute with redundant information.

In an embodiment of the invention, said at least two different kinds of sensors have different labels.

In an embodiment of the invention, said at least two different kinds of sensors have different shapes.

In an embodiment of the invention, said at least two different kinds of sensors have different sizes.

According to these preferred embodiments of the invention, the user may be able to recognize the different sensors based on their labelling, their shapes or their size. Other possible differentiations are possible as well, such as e.g. different colors, different texture, etc.

In an embodiment of the invention, said at least one sensor is wireless.

This very preferred embodiment of the invention enables the user to place the sensors anywhere, and easily move them around according to his needs.

In an embodiment of the invention, said at least one sensor is driven by batteries.

In an embodiment of the invention, said batteries are rechargeable.

In an embodiment of the invention, said user interface comprises at least one holder for at least one of said at least one sensor.

In an embodiment of the invention, said holder comprises means for recharging said batteries.

This very preferred embodiment of the invention having wireless sensors, rechargeable batteries and a holder with means for recharging, features fast and uncomplicated set up of the sensors before use, and accordingly fast and easy removal of them afterwards. This is especially advantageous when the system is used in a private home. The holder may perfectly hold more sensors than ever used at once, as different sensors may be needed at different times for different users or exercises.

In an embodiment of the invention, said holder comprises differently labelled slots for said at least two different kinds of sensors.

In an embodiment of the invention, said holder comprises differently shaped slots for said at least two different kinds of sensors.

In an embodiment of the invention, said holder comprises differently sized slots for said at least two different kinds of sensors.

According to these very preferred embodiments of the invention, the user may be able to recognize the different sensors based on their place in the holder, and be able to put them back on the same places as well. Different sensors may e.g. have different needs of recharging, and it may hence be important to place the sensors in the right slots.

In an embodiment of the invention, said at least one sensor comprises means for wireless data communication.

According to this very preferred embodiment of the invention, the sensors are able to communicate with the user interface without the need of physical connections. This greatly improves the flexibility and user-friendliness of the system.

In an embodiment of the invention, said means for wireless communication comprise a network interface.

According to this preferred embodiment of the invention, each sensor appears as a network node. If all sensors and the user interface are defined as nodes in the same network, the user interface does not need to comprise individual hardware implemented communication channels for each sensor.

Furthermore this embodiment enables the sensors to communicate with each other as well. This may be very beneficial, as it e.g. enables the sensors to help each other decide which of them contributes at the moment with the most useful data, and thus may be assigned a higher priority, and accordingly which of them only contributes with redundant data, and thus may be suspended.

In an embodiment of the invention, said network interface comprises protocols of the TCP/IP type.

With this embodiment of the invention it is possible to establish a communication between the user interface and the sensors, and between the sensors, using common Internet and network technology.

In an embodiment of the invention, said calibration means comprise means for calibration of a reference position.

With this preferred embodiment of the invention, the user interface is able to determine a reference position from where motions are performed. This may also be referred to as “resetting”.

In an embodiment of the invention, said calibration of a reference position is predefined.

This embodiment of the invention comprises predefined reference positions, i.e. starting point of motions. This may be beneficial when very strict use of the system is required.

In an embodiment of the invention, said calibration of a reference position is performed automatically.

This very preferred embodiment of the invention enables the user to begin using the system from any position and posture. The user interface automatically defines the user's starting point as reference position for the following motions. This feature enables the system to be very flexible, and is a great advantage when the system is used for e.g. rehabilitation, where different users with different problems and limitations make use of it. In a preferred embodiment of the invention, a predefined reference position is also provided for optional use, e.g. when the user interface is unable to automatically determine a reference position.

In an embodiment of the invention, said calibration of a reference position is performed manually.

This embodiment of the invention enables the user to define a position to be used as reference position. This is an advantageous feature when a high degree of precision is needed, or when e.g. a therapist wants to be in control of the calibration. It may however be disadvantageous if this is the only way to define a reference position. A very preferred embodiment of the invention comprises predefined reference positions, automatic detection of reference position and thereto the possibility of defining it manually.

In an embodiment of the invention, said calibration of a reference position is performed for each sensor individually.

With this preferred embodiment of the invention, a reference position is associated with each sensor in use. This enables the user interface to comprise sensors of different kinds, and sensors in different distances from the user.

In an embodiment of the invention, said calibration means comprise means for calibration of active range.

According to this very preferred embodiment of the invention, the user interface may limit the active range of the sensors. This is very beneficial when only a part of a sensors range is actually used with a certain user or for a certain exercise. When the range is limited to the range actually used, it is possible to use the sensor output relative to the limited range, instead of relative to the full range. This enables the user interface to establish control signals from a user with only small gestures, comparable to control signals from a user with big gestures.

The active range may be defined for each sensor, as it depends highly on each sensor's position and direction relative to the movements.

In an embodiment of the invention, said calibration of the active range is predefined.

This embodiment of the invention comes with a predefined active range for each sensor. This may be beneficial for systems only used with certain, pre-known positions of the sensors, and pre-known range of movements relative thereto.

In an embodiment of the invention, said calibration of the active range is performed manually.

According to this very preferred embodiment of the invention, the user, e.g. a patient or a therapist, may define for each sensor an active range. This introduces great flexibility of the system, and is especially an advantage in rehabilitation purposes, as it enables the therapist to adapt the user interface to the abilities of the patient, or maybe rather to the aiming of the rehabilitation session.

In an embodiment of the invention, said calibration of the active range is performed automatically.

According to this very preferred embodiment of the invention, the user interface determines the active range of each sensor automatically either continuously during use or initiated by the user before use. This embodiment of the invention features less flexibility than manual calibration of the active ranges, but introduces a high degree of user-friendliness.

A very preferred embodiment of the invention comprises both possibilities, and lets the user decide whether to manually or automatically define the active ranges.

In an embodiment of the invention, said control system comprises means for automatic decision of which sensors to use.

According to this embodiment of the invention, the system may automatically decide to utilize certain of the available sensors and disregard others if those may be determined to provide superfluous information.

The decision making means may be decentral, e.g. included in the individual sensors or it may be central, e.g. included in the central data processing platform, e.g. the hosting computer.

In an embodiment of the invention, said motion detection sensors are permanently positioned on walls.

According to this preferred embodiment of the invention, the sensors may be more or less permanently positioned in or on the walls of a room or more rooms. Thereby a room with a built-in remote control is obtained.

The invention further relates to a use of the above described control system in a rehabilitation system.

The invention further relates to a use of the above described control system for data analysis system.

The invention further relates to a use of the above described control system in a remote control system.

In an embodiment of the invention, said remote control system is used for controlling an intelligent room.

This embodiment may be used to control almost anything within the home or the room, simply by making gestures in the room. By applying appropriate sensors, the system may furthermore automatically identify the person currently making gestures and e.g. use his special preferences, his mapping tables, and it may even know his intentions.

By intelligent room is understood a room including a set of rooms, e.g. a home, a patient room, etc., where some devices and appliances are operable from a distance. This may comprise motorized curtains, TV-sets, computers, communication devices, e.g. telephone, video games, motorized windows, etc.

By applying appropriate interfaces to the control means any electronic appliance, any electrical machine, and any mechanism that are motorized may be connected to the present invention, thus facilitating the user to control everything by gestures, letting everything automatically adapt to the current user when the system identifies him, etc.

This embodiment of the invention is especially advantageous when used in e.g. homes or patient rooms with a bed-ridden patient as user. Such a user may not be able to open a window, to get some fresh air, draw the curtains to shield him from the sun, call a nurse, change TV channels, etc. with conventional methods. With the present invention however he may be able to perform almost all the same functions as a not disabled person.

By furthermore adding speech recognition to the system, a very advantageous intelligent home remote control has been obtained.

The invention further relates to a use of the above described control system for interactive entertainment.

According to this preferred embodiment of the invention, the system may be used as interface to all kinds of interactive entertainment systems. Thus, e.g. movement or gesture-controlled lightning may be achieved by combining this embodiment of the present invention with intelligent robotic lights. Another example of interactive entertainment achievable through this embodiment of the invention comprises conduction, creation or triggering of music interactively through gestures or cues.

In an embodiment of the invention, said interactive entertainment comprises virtual reality interactivity.

This embodiment of the present invention enables the user to interact with virtual reality systems or environments without the need of special gloves or body suits.

The invention further relates to a use of the above described control system for controlling three-dimensional models.

According to this preferred embodiment of the invention, the system may be used to control or navigate three-dimensional models, e.g. created by a computer and visualized on a monitor, in special glasses, or on a wall-size screen.

Three-dimensional models may e.g. comprise buildings or human organs and the experience to the user may then comprise walking around inside a museum looking at art, or travelling through the internals of a human heart to prepare on a surgery.

The invention further relates to a use of the above described control system in learning systems.

According to this embodiment of the invention, an advantageous interface to learning systems is provided.

An example of such use may comprise a system that acts both as activation and learning tool for development. The system is personalised to the family voices, interests, and daily routine with sleeping, bathing, eating and playing. It consists of sensors, feedback system with graphics, e.g. a flat screen, and sound, e.g. speakers, and perhaps motion, e.g. toys that communicate with the system or attached items to the system itself such as a hanging mobile. The system will help a baby to fall asleep with songs and visuals and perhaps rocking or vibrations of the bed. It will activate the child when it wakes up with toys and interactivity. It will teach the child to speak by picking up sounds and reinforcing communication through feedback in sound and visuals and activation of toys. It will continue to develop along with the child such that spelling and arithmetic and movement reinforcement will be advanced concurrently with the child's stage of development.

The system is able to integrate with the items in the household, e.g. by games that can be activated on a TV in the living room or a flat panel by the bed or sound that can be created through the equipment with the system or through other audio equipment in the house. Furthermore, the system facilitates surveillance of the child when e.g. the child sleeps in a bedroom while the parents watch TV in the living room. Cameras monitoring the child may be automatically activated on recognition of baby motion, e.g. crawling, laying, rocking, small steps, etc. Alternatively the recognition of baby motion may result in different kinds of relaxation or activation means being activated.

The invention further relates to a motion detector comprising a set of partial detectors of different types with respect to detection characteristics.

According to an embodiment of the invention, a combined detector functionality may be established as a combination of different detectors and where at least two of the detectors feature different detection characteristics. In this way, a detector may be optimized for different purposes if so desired. This may for instance be done by the incorporation of the output of certain types of detectors when certain types of motions are performed in certain environments.

In other applications partial detectors may be applied depending on the obtained output.

According to a preferred embodiment of the invention, such calibration and selection of the best performing transducers may simply be performed by the user demonstrating the motions to be detected and then subsequently determining what transducers feature the best differential output.

Evidently, the combined motion detector output may be pre-processed prior to handing over of the motion detector output to the application controlled by the motion detector.

In an embodiment of the invention, the motion detector is adaptive.

The invention further relates to a motion detector for use in a system as described above.

### LIST OF DRAWINGS

The invention is in the following described with reference to the drawings, of which

FIG. 1 illustrates the terms “in body”, “on skin” and “kinesphere”,

FIG. 2 shows a conceptual overview of the invention,

FIG. 3 shows an overview of a first preferred embodiment of the invention,

FIG. 4 shows an overview of a second preferred embodiment of the invention,

FIG. 5 shows a preferred sensor setup,

FIG. 6 shows a second preferred sensor setup,

FIG. 7 shows a combination of the setups in FIGS. 5 and 6,

FIG. 8 shows a calibration interface for manual calibration,

FIG. 9 shows a calibration interface for automatic calibration,

FIG. 10 shows a calibration interface for both manual and automatic calibration,

FIG. 11 shows a preferred embodiment of the invention, and

FIG. 12a-12c illustrate further advantageous embodiments of the invention.

### DETAILED DESCRIPTION

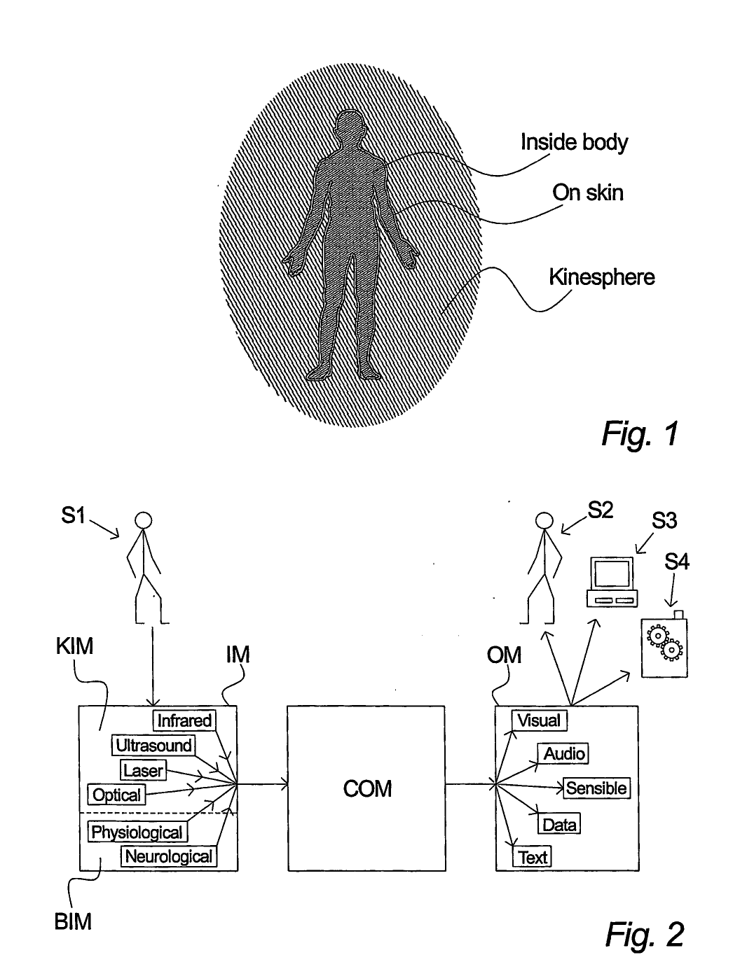

FIG. 1 is provided to define some of the terms to be used in the following. It shows an outline of a human being. The outline also illustrates the skin of the person. The area inside the outline illustrates the inside of the body. The area outside the outline illustrates the kinesphere of the person. The kinesphere is the space around a person, in which he is able to move his limbs. For a healthy, fully developed person, the kinesphere thus covers a greater volume than for a severely handicapped person or a child.

In the following are references to sensors, detectors or probes that may be implemented into the inside of the body, applied directly on the skin, e.g. to detect heart rate or neural activity, or positioned remote from the body to detect events in the kinesphere, e.g. a person stretching his fingers or waiving his arm. Different kinds of sensors are suitable to perform measurements in the different areas mentioned above. An infrared sender and receiver unit may e.g. be very suitable for detecting movements of limbs in the kinesphere, while it is unusable for detecting physiological parameters inside the body.

FIG. 2 shows a conceptual overview of the invention. It comprises a communication system COM, a bank of input media IM and a bank of output media OM. Examples of possible input media and output media are provided in the appropriate boxes. According to the above discussion on measure areas, the bank of input media is divided into two sub banks, thus establishing a bank of input media operating in the kinesphere, kinespheric input media KIM, and a bank of input media operating in the body or on the skin, in-body/on-skin input media BIM.

Furthermore the figure comprises a first subject S1, e.g. a human being, on which the input media IM operates, a second subject S2, e.g. a human being, possibly the very same person as first subject S1, a third subject S3, e.g. a computer or another intelligent system and a fourth subject S4, e.g. a machine. The second, third and fourth subjects S2, S3, S4, receive the output from the output media OM.

It is again noted that the input media and output media mentioned in FIG. 2 are merely examples of such media, and that the present invention may be used with any input media and output media suitable for the purpose. The same applies to the four subjects S1-S4, which accordingly may be any subjects applicable, and be any number thereof.

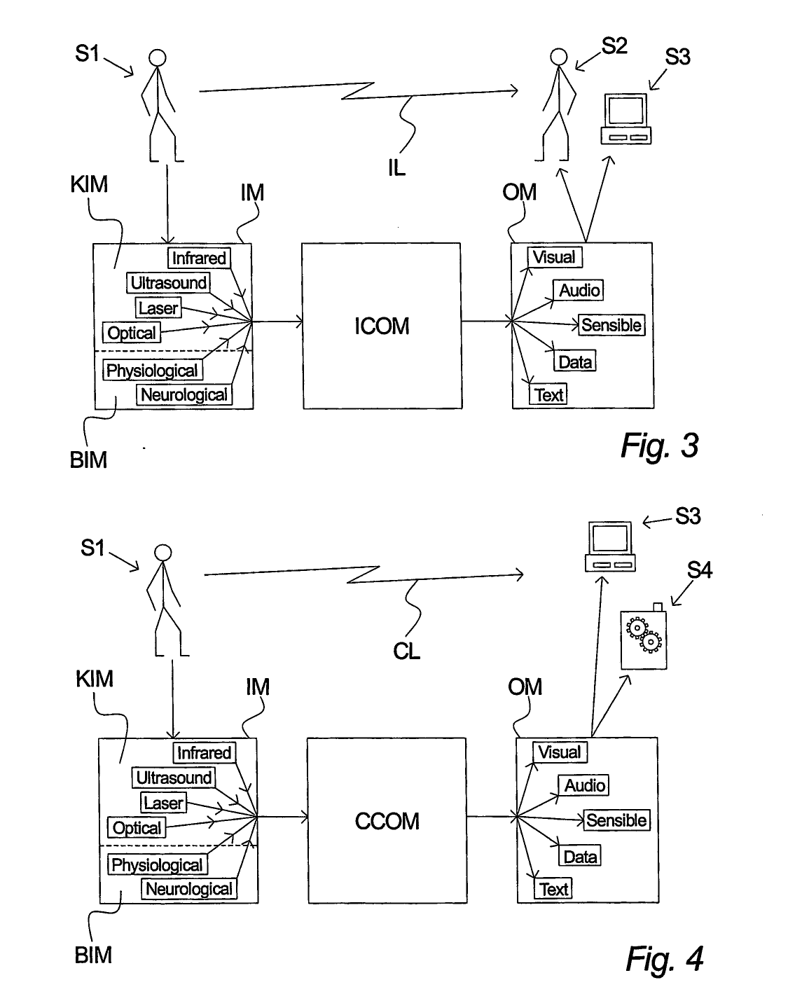

FIGS. 3 and 4 each comprises preferred embodiments derived from the conceptual overview in FIG. 2. FIG. 3 shows a preferred embodiment for communication of information, e.g. messages, requests, expression of feelings etc. Between the first subject S1 and the second and third subjects S2, S3 is symbolically shown an information link IL, as this embodiment of the invention establishes such a link, which to the subjects S1, S2, S3 involved may feel like a direct communication link, to e.g. substitute speech.

Compared to the conceptual FIG. 2, the communication system COM is specified to be of an information communication system ICOM type, and the fourth subject S4 is removed, as it does not apply to an information communication system.

FIG. 4 shows a preferred embodiment for communication of control commands, e.g. “turn on”, “volume up”, “change program”, etc. Between the first subject S1 and the third and fourth subjects S3, S4 is symbolically shown a control link CL, as this embodiment of the invention establishes such a link, which to the subjects S1, S2, S3 involved may feel like a direct communication link, to e.g. substitute pushing buttons or turning wheels, etc.

Compared to the conceptual FIG. 2, the communication system COM is specified to be of a control communication system CCOM type, and the second subject S2 is removed, as it does not apply to a control communication system. This embodiment of the invention is especially aimed at controlling machines, TV-sets, HiFi-sets, computers, windows etc.

In the following the present invention and its elements are described in more detail. Only input media, i.e. sensors, from the group operating in the kinesphere of the subjects are used in the following embodiments of the invention, as all preferred embodiments make use of these media.

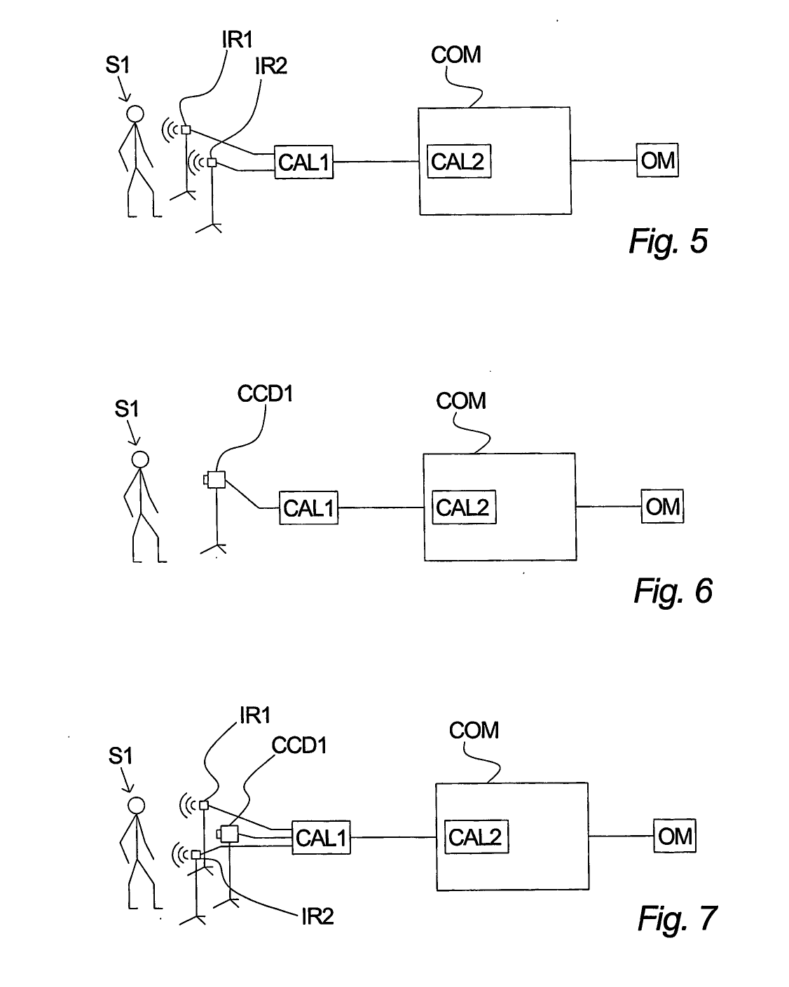

FIGS. 5, 6 and 7 shows three preferred embodiments of the sensor and calibration setup. All three figures comprise a first subject S1, a number of sensors IR1, IR2, CCD1, a first calibration unit CAL1, a communication system COM, and output media OM. The communication system COM comprises a second calibration unit CAL2.

FIG. 5 shows a setup with two infrared sensors IR1, IR2. The infrared sensors are not restricted to be of a certain type or make, and may e.g. each comprise an infrared light emitting diode and an infrared detector detecting reflections of the emitted infrared light beam. The sensors are placed in front of, and a little to each side of the first subject S1, both pointing towards him. Both sensors are connected to the first calibration unit CAL1.

FIG. 6 shows an alternative setup introducing a digital camera CCD1, which may e.g. be a web cam, a common digital camcorder etc., or e.g. a CCD-device especially designed for this purpose. The camera CCD1 is positioned in front of the first subject S1, and pointing towards him. The camera is connected to the first calibration unit CAL1.

The two types of sensors, infrared and CCD, used in the above description, are only examples of sensors. Any kind of device or combination of devices able to detect movements within the kinesphere of the first subject is suitable. This comprise, but not exclusively, ultrasound sensors, laser sensors, visible light sensors, different kinds of digital cameras or digital video cameras, radar or microwave sensors and sensors making use of other kinds of electromagnetic waves.

Furthermore any number of sensors is within the scope of the invention. This comprises the use of e.g. only one infrared sensor, three infrared sensors, a sensor bank with several sensors, two CCD-cameras positioned perpendicular to each other to e.g. support movements in three dimensions. A very preferred use of sensors is shown in FIG. 7, where one CCD-camera CCD1 is combined with two infrared sensors IR1, IR2.

With a preferred embodiment of the invention, the sensors are connected with the calibration unit CAL1 or the communication system COM with a wireless connection, as e.g. IrDA, Bluetooth, wireless LAN or any other common or special designed wireless connection method. Furthermore the sensors may be driven by rechargeable batteries, as e.g. the NiCd, NiMH or Li-Ion kinds of batteries, and thereby be easy to position anywhere and simple to reposition according to the needs of a certain use-situation. A combined holder and battery charger may be provided, in which the sensors may be placed for storing and recharging between uses. When the system is to be used, the sensors needed for the specific situation is taken from the holder and placed at appropriate positions. Alternatively, e.g. for systems always used at the same place for the same purpose, the sensors may have their own separate holders at fixed positions.

A key element of the present invention is the calibration and adaptation processes. In a preferred embodiment, the system is calibrated or adapted according to several parameters, e.g. number and type of sensors, position, user etc. Common to the different calibration and adaptation processes are that they may each be carried out automatically or manually and by either hardware, software or both. This is illustrated in the above-described FIGS. 5, 6 and 7, by the first and second calibration units CAL1, CAL2. Each of these may control one or more calibration or adaptation processes, and be manually or automatically controlled. Either one of the calibration units may even be discarded, letting the other calibration unit do all calibration needed. In the following the different calibration processes are described in their preferred embodiments.

A first calibration process for each sensor in use is to reset its zero reading, i.e. determine a reference position of the user, from where motions are performed. This reference position may for each sensor or type of sensor be predefined, or it may be automatically or manually adjusted on wish. One embodiment with such predefined zero-position may e.g. be an infrared sensor presuming the user to be standing 2 metres away in front of it. This embodiment has some disadvantages, as the user probably will experience some shortcomings or failures, if he is not positioned exactly like the sensors implies.

In a very preferred embodiment of the invention, the determination of reference position, i.e. resetting, for each sensor in use, is performed automatically, for each use session, when the sensor first detects the user. When the sensor detects anything different from infinity, its current reading defines the reference position, i.e. zero. Afterwards, during the rest of that session, the sensor readings are evaluated according to the user's initial position. This embodiment is very advantageous, as the user does not need to worry about his position, and he may change position according to the kind of motions he is performing, or his physical abilities.

An alternative embodiment of the above is where the reference position is defined manually. With this embodiment the user may first position himself, and then he, an assistant or a therapist may push a button, do a certain gesture etc., to request that position to be determined reference position. This embodiment facilitates changes of reference position during a use session.

A second calibration process is a calibration regarding the physical extent of the motions or gestures to be used in the current use session. A system for remotely controlling a TV-set by making different gestures with a hand and fingers will preferably require only a small spatial room, e.g. 0.125 cubic metres, to be monitored by the sensors, whereas a system for rehabilitation of walking-impaired or persons having difficulties keeping their balance requires a relatively big spatial room, e.g. 3-5 cubic metres, to be monitored.

As with the previous calibration process, the monitored spatial room may be predefined, automatically configured during use, or manually configured. With a predefined spatial room of monitoring, the system is very constricted, and is unfit for rehabilitation uses. On the contrary, a system for remotely controlling a TV-set, as explained above, may benefit from being as predefined as possible, as simplicity of use is an important factor for such consumer products, and, because of the limited range of uses, it is not possible to configure better at home, than the manufacturer in his laboratory.

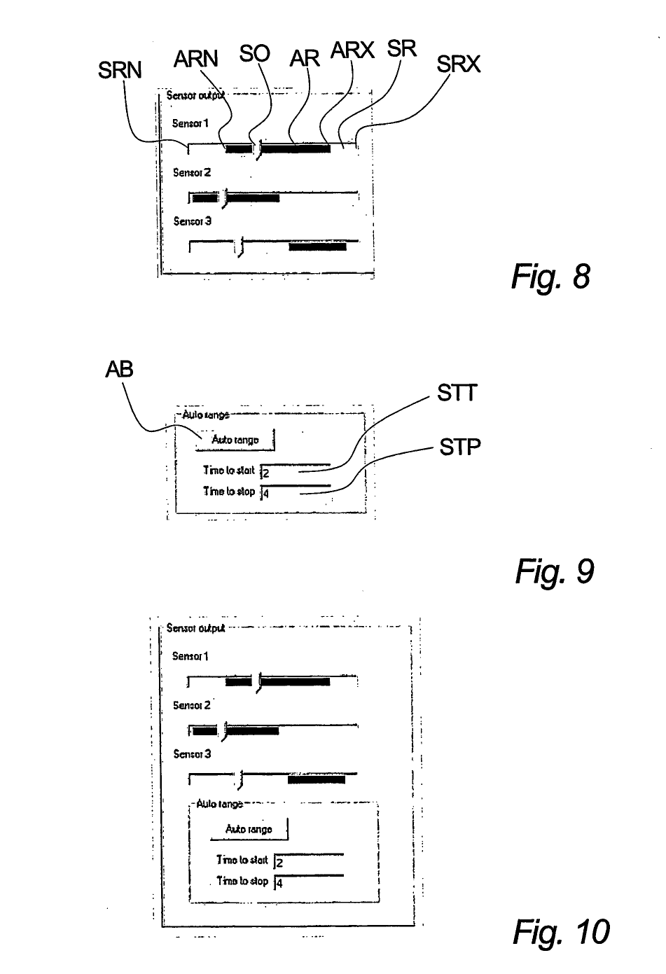

FIG. 8 shows a preferred embodiment of manual calibration of the physical extent to monitor. It comprises a screenshot from a hardware implemented software application, showing the calibration interface.

This example comprises three sensors of the infrared type. For each sensor is shown a sensor range SR, comprising a sensor range minimum SRN and a sensor range maximum SRX. The sensor range represents the total range of the associated sensor, and is accordingly highly dependent on the type of sensor. If e.g. an infrared sensor outputs values in the range 0 to 65535, then the sensor range minimum SRN represents the value 0, and sensor range maximum SRX represents the value 65535. With an ultrasound sensor outputting values in a range −512 to 511, the sensor range minimum SRN is −512 and the sensor range maximum is 511. However, these values are not shown in the calibration interface, as they are not important to the user, due to the way the calibration is performed. Thus the calibration interface looks the same independently of the types of sensors used.

The calibration interface further comprises an active range AR for each sensor. The active range AR comprises an active range minimum ARN and an active range maximum ARX. The active range AR represents the sub range of the sensor range SR that is to be considered by the subsequent control and communication systems. The locations of the values active range minimum ARN and active range maximum ARX may be changed by the user, e.g. with the help from a computer mouse by “sliding” the edges of the dark area. By changing these values, a sub range of the sensor range SR is selected to be the active range AR.

To help the user define the best possible active range AR for a certain use of the system, the sensor output SO is shown in the calibration interface as well. The sensor output SO represents the current output of the actual sensor, and is automatically updated while the calibration is performed. When the user actually moves in front of the sensor, the sensor output SO slider moves correspondingly. This slider is not changeable by the user by means of e.g. mouse or keyboard, but only by interacting with the sensor. By performing the motions intended for the exercise and at the same time watching the sensor output SO slider, and changing the active range AR to reflect the range in which the sensor output SO travels, an optimal calibration regarding physical extent is achieved. This should be performed for each sensor to be used, each time a different exercise or use of the system is intended. In a very preferred embodiment of the invention, the system is able store different calibrations of physical extent, and knows which calibration to use with which exercise.

To make it possible to use any kind of sensor with any kind of output media or subsequent control system, it is necessary to scale the sensor range, which may depend on the type of sensor, to a common range, which should always be the same for the sake of establishing a common output interface to subsequent systems. This scaling is performed within the calibration unit CAL1 or CAL2 as well as the calibration, because both the active range minimum ARN and maximum ARX and the common range minimum and maximum for the output interface has to be known to do a correct scaling. When e.g. the output interface common range is defined to be e.g. 0 to 1023, and the active range of the sensor is calibrated to be e.g. −208 to +63, then the current sensor output is scaled to the common range by adding +208 to it, multiplying it with 1024, and finally dividing it with (63−(−208)+1)=272. A sensor output of e.g. −21 is thereby scaled to the common range value 704 as so:
(−21+208)*1024/(63−(−208)+1)=704.

The value 704 out of a range of 1024 possible values with zero offset is the same as the value −21 out of a range of 272 possible values with an offset of −208.

In the above examples of sensor ranges and range scaling, due to clarity, only integers are used. The present invention may however be implemented using decimal numbers, floating point numbers or any other data format numbers applicable.

FIG. 9 shows an example of a calibration interface used with an embodiment of the invention having automatic active range calibration means. The interface comprises an auto range button AB, a box for inputting a start time STT and a box for inputting a stop time STP. When the auto range button AB is pushed, the calibration unit will wait the amount of seconds specified in the start time field STT, e.g. 2 seconds, and will then auto-calibrate for the amount of seconds specified in the stop time field STP, e.g. 4 seconds. During this time, the user should be in the position intended for the exercise, doing the movements likewise intended. Thereby the calibration unit CAL1 or CAL2 is able to determine a travel range of the sensor output SO for each sensor, and set the active range minimum ARN and maximum ARX accordingly.

In an alternative embodiment of the invention, the auto-calibration is performed automatically several times during an exercise, instead of or in addition to requesting the user to push the auto range button AB. When the calibration is performed this way the user may not know, and it may consequently be preferred to let each calibration last for a significantly longer period than when the user is aware of the calibration taking place. Furthermore, when using the automatically initiated calibration several times during an exercise, the system may always know which, if any, of the sensors are not used or are merely outputting redundant or unusable data. When using a system where e.g. the amount of sensor data is a problem, e.g. because of the number of sensors, the precision of the data, a wireless communication bottleneck, etc., it may be beneficial to let the system be able to determine sensors not contributing constructively to the data processing, and thereby enable it to ignore these.

FIG. 10 shows a calibration interface of an embodiment facilitating both manual and automatic calibration. It comprises the elements of both FIG. 8 and FIG. 9. By combining the manual and automatic calibration, a very advantageous embodiment of the invention is achieved, as the user may now use the auto range button AR to quickly obtain a rough calibration, and, if needed, may afterwards fine-tune the calibration settings.

Even if the user never uses the manual calibration possibility, he may though make use of the knowledge about the current calibration settings also obtainable from the manual calibration interface.

It is noted that the calibration interface embodiments shown in the FIGS. 8, 9 and 10 are only examples, and are all hardware implemented software interfaces, preferably implemented in the second calibration unit CAL2. The calibration may however be performed in any of the calibration units CAL1 or CAL2, and the calibration interface may be implemented in hardware only, e.g. with physical sliders or knobs, or in software, incorporating any appropriate graphical solution. The calibration of active ranges of the sensors may as well be performed by software or hardware, or a combination.

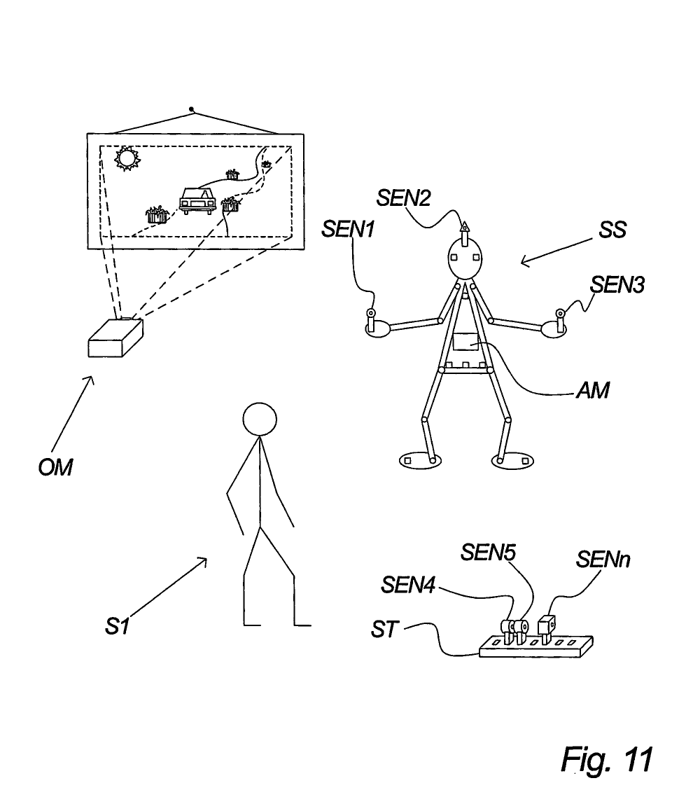

FIG. 11 shows a preferred embodiment of the invention. It comprises a first subject S1, subject to rehabilitation, a sensor stand SS, a sensor tray ST and output media OM. Furthermore several sensors SEN1, SEN2, SEN3, SEN4, SEN5 and SENn are comprised. Three of them are put on the sensor stand, and the rest are placed in the sensor tray ST. The sensor stand SS furthermore holds adaptation means AM. The output media OM are a projector showing a simple computer game on a screen.

The sensors SEN1, SEN2, . . . , SENn have different shapes, cylindrical, triangular and quadratic, to enable a user to distinguish them from each other. For the embodiment shown in FIG. 4, the cylindrical sensors SEN1, SEN3, SEN4 and SEN5 may be of an infrared type, while the triangular sensor SEN2 may be a digital video camera, and the quadratic sensor SENn may be of an ultrasound type.

The different shapes enables the user to distinguish between the sensors, even without any knowledge of their comprised technologies or their qualities. A more trained user, e.g. a therapist, may further know the sensors by their specific qualities, e.g. wide range or precision measurements, and may associate the sensor's qualities with their shapes. This is a very advantageous embodiment of the sensors, as it greatly improves user-friendliness and flexibility, and it moreover enables the manufacturer to apply a common design to all sensors, regardless of them being cameras of laser sensors, as long as just one visible distinctive feature is provided for each sensor type. The simple distinction of sensors in opposition to a more technical distinction also enables the configuration means, user manual or other to easily refer the specific sensor types, with a language everybody understands.

The shape of the sensor stand SS is intended to be associated with the outline of a human body. The sensor stand SS comprises a number of bendable joints BJ, placed in such a way that the legs and the arms of the stand may be bended in much the same way as the equivalent legs and arms of a human body. The sensor stand SS further comprises a number of sensor plugs SP, placed at different positions on the stand, in such a way that a symmetry between the left and the right side of the stand is obtained. Furthermore the sensor stand SS comprises adaptation means AM.

The shape of a human body is preferred, as it is more pedagogic than e.g. microphone stands or other stands or tripod usable for holding sensors. When the system is used with e.g. handicapped persons or children, pedagogically formed devices are very preferred. It is however noted that any shape or type of stand suitable for holding one or more sensors is applicable to the system.

The sensor plugs SP make it possible to place sensors on the stand, and may beside real plugs be clamps or sticking materials such as e.g. Velcro (trademark of Velcro Industries B.V.), or any other applicable mounting gadget. The positions of the sensor plugs are selected form knowledge of possible exercises and users of the system. Preferably there are several more sensor plugs than usually used with one exercise or one user, to increase the flexibility of the sensor stand. When e.g. the sensor stand is used for rehabilitation at a clinic, where different patients make different exercises under guidance of different therapists, a flexible sensor stand with several possible sensor locations is preferred. On the other hand, less possible sensor positions make the stand simpler to use, and it may besides be cheaper to manufacture. Such an alternative may be preferred by a single user having the stand in his home to regularly perform a single exercise.

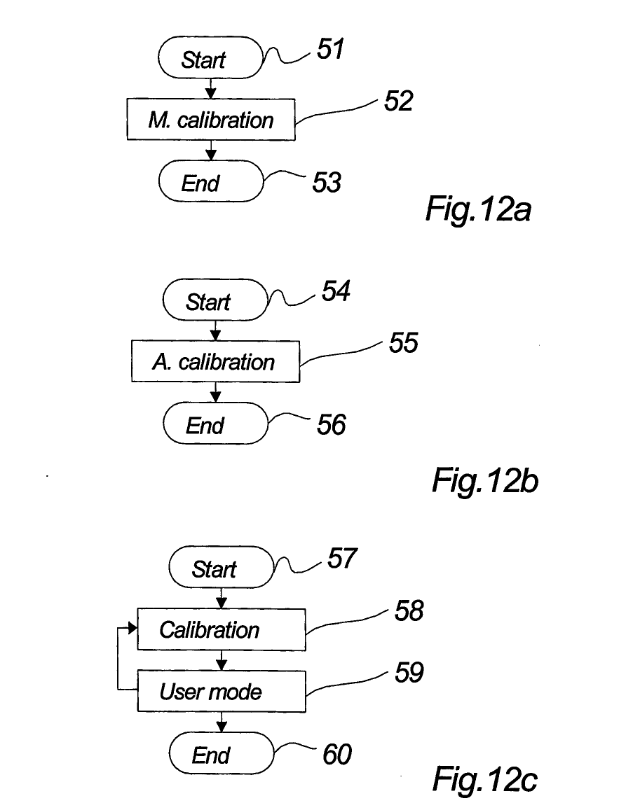

FIG. 12a to 12c illustrate further advantageous embodiments of the invention. Basically, the figures illustrate different ways of calibrating detectors, preferably motion detectors such as IR-detectors, CCD detectors, radar detectors, etc. Evidently, according to a preferred embodiment of the invention, the applied detectors are near field optimized.

The illustrated calibration routines may in principle be applied, but not restricted to, the embodiment illustrated in FIG. 1 to 11.

FIG. 12a illustrates a manual calibration initiated in step 51. When entering step 52, a manual calibration is initiated. A manual calibration may simply be entered by the user manually activating a calibration mode, typically prior to the intended use of a certain application. It should, however, be noted that a calibration may of course be re-used if the user desires to use the same detector setup with the same application or re-use the calibration as the starting point of a new calibration.

The manual calibration may for example be performed as a kind of demonstration of the movement(s) the system and the setup is expected to be able to interpret. Such demonstration may for example be supported by graphical or e.g. audio guidance, illustrating the detector system outputs resulting from the performed movements. The calibration may then be finalized by applying a certain interpretation frame associated to the performed movements.

The interpretation frame may for example be an interval of X, Y (and e.g. X) coordinates associated to the performed movement and/or for instance an interpretation of the performed movements (e.g. gestures) into command(s).

The manual calibration should preferably, when dealing with high resolution systems, be supported by a sought calibration wizard actively guiding the user through the calibration process, e.g. by informing the user of the next step in the calibration process and on a run-time basis throughout the calibration informing the user of the state of the calibration process. This guidance may also include the step of asking the calibrating user to re-do for instance a calibration gesture to ensure that the system may in fact make a distinction between this gesture and another calibrated gesture associated to another command.

In step 53 the calibration is finalized.

FIG. 12b illustrates a further embodiment of the invention

FIG. 12b illustrates an automatic calibration initiated in step 54. When entering step 55, an automatic calibration is initiated. An automatic calibration may simply require a certain input by the user, typically the gesture of a user, and then automatically establish an interpretation frame

In step 56 the calibration is finalized.

FIG. 12c illustrates a hybrid adaptive calibration. In other words, the application may subsequently to a manual or automatic calibration procedure in step 58 enter the running mode of an application in step 59. The calibration may then subsequently be adapted to the running application without termination of the running application (when seen from the user)

Such hybrid adaptive calibration may e.g. be performed as a repeated calibration performed in certain intervals or activated by certain user acts and calibrated to for example the last five minutes of user inputs.

Several other calibration routines or calibration acts may be performed within the scope of the invention.

1. A control system comprising
control means; and
a user interface, said user interface comprising means for communication of control signals from a user to said control means, said user interface being adaptive.

2. A control system according to claim 1, wherein said user interface comprises:
motion detection means;
output means; and
adaption means adapted for receipt of motion detection signals obtained by said motion detection means, establishing an interpretation frame on the basis of said motion detection signals and establishing and outputting communication signals to said output means on the basis of said motion detections signals and said interpretation frame.

3. A control system according to claim 2, wherein said user interface comprises signal processing means or communicates with motion detection means determining obtained signal differences by comparison with the signals obtained when establishing said interpretation frame.

4. A control system according to claim 1, wherein said user interface is distributed.

5. A control system according to claim 2, wherein said motion detection means comprises a set of motion detection sensors.

6. A control system according to claim 5, wherein said set of motion detection sensors is exchangeable.

7. A control system according to claim 5, wherein said set of motion detection sensors forms a motion detection means combining at least two motion detection sensors wherein an individual motion detection sensor may be exchanged with another motion detection sensor.

8. A control system according to claim 5, wherein said set of motion detection sensors comprises at least two different types of motion detection sensors.

9. A control system according to claim 2, wherein said motion detection means may be optimized by a user to an intended purpose by exchanging or adding motion detection sensors, said motion detector sensors including at least two different types of motion detection sensors.

10. A control system according to claim 8, wherein said at least two different types of motion detection sensors are mutually distinguishable.

11. A control system according to claim 1, wherein said user interface comprises remote control means.

12. A control system according to claim 5, wherein said motion detection sensors are driven by rechargeable batteries.

13. A control system according to claim 5, wherein said motion detection means comprises a sensor tray for holding said motions detection sensors.

14. A control system according to claim 13, wherein said sensor tray comprises means for recharging said motion detection sensors.

15. A control system according to claim 2, wherein said motion detection signals and/or said communication signals are transmitted by wireless communication.

16. (canceled)

17. A control system according to claim 15, wherein said wireless communication exploits Bluetooth technology.

18. A control system according to claim 15, wherein said wireless communication exploits wireless network technology.

19. A control system according to claim 15, wherein said wireless communication exploits wireless broadband technology.

20. A control system according to claim 15, wherein said wireless communication exploits UMTS technology.

21. A control system according to claim 1, wherein said control signals represent control commands.

22. A control system according to claim 1, wherein said control signals represent information.

23. A control system according to claim 1, wherein said user interface comprises motion detection means.

24. A control system according to claim 1, wherein said motion detection means is touch-less.

25. A control system according to claim 1, wherein said user interface comprises mapping means.

26. A control system according to claim 1, wherein said user interface comprises calibration means.

27. A control system according to claim 1, wherein said control means comprises means for communicating said signals to at least one output medium.

28. A control system according to claim 25, wherein said mapping means comprises predefined mapping tables.

29. A control system according to claim 25, wherein said mapping means comprises user-defined mapping tables.

30. A control system according to claim 25, wherein said mapping means comprises at least two mapping tables.

31. A control system according to claim 25, wherein said mapping means comprises at least two mapping tables and a common control mapping table.

32. A control system according to claim 25, wherein said mapping means comprises motion learning means.

33. A control system according to claim 32, wherein said motion learning means comprises means for testing and validating new motions.

34. A control system according to claim 2, wherein said motion detection means comprises at least one sensor.

35. A control system according to claim 34, wherein said at least one sensor is an infrared sensor.

36. A control system according to claim 34, wherein said at least one sensor is an optical sensor.

37. A control system according to claim 36, wherein said optical sensor is a CCD-based sensor.

38. A control system according to claim 36, wherein said optical sensor is a digital camera.

39. A control system according to claim 36, wherein said optical sensor is a digital video camera.

40. A control system according to claim 36, wherein said optical sensor is a web camera.

41. A control system according to claim 34, wherein said at least one sensor is an ultrasound sensor.

42. A control system according to claim 34, wherein said at least one sensor is a laser sensor.

43. A control system according to claim 34, wherein said at least one sensor is an electromagnetic wave sensor.

44. A control system according to claim 2, wherein said motion detection means comprises at least two different kinds of sensors.

45. A control system according to claim 44, wherein said at least two different kinds of sensors are used simultaneously.

46. A control system according to claim 44, wherein said at least two different kinds of sensors have different labels.

47. A control system according to claim 44, wherein said at least two different kinds of sensors have different shapes.

48. A control system according to claim 44, wherein said at least two different kinds of sensors have different sizes.

49. A control system according to claim 34, wherein said at least one sensor is wireless.

50. A control system according to claim 34, wherein said at least one sensor is driven by batteries.

51. A control system according to claim 50, wherein said batteries are rechargeable.

52. A control system according to claim 34, wherein said user interface comprises at least one holder for at least one of said at least one sensor.

53. A control system according to claim 52, wherein said holder comprises means for recharging batteries.

54. A control system according to claim 44, wherein a holder comprises differently labeled slots for said at least two different kinds of sensors.

55. A control system according to claim 54, wherein said holder comprises differently shaped slots for said at least two different kinds of sensors.

56. A control system according to claim 54, wherein said holder comprises differently sized slots for said at least two different kinds of sensors.

57. A control system according to claim 34, wherein said at least one sensor comprises means for wireless data communication.

58. A control system according to claim 57, wherein said means for wireless communication comprises a network interface.

59. A control system according to claim 58, wherein said network interface comprises protocols of the TCP/IP type.

60. A control system according to any of the claim 26, wherein said calibration means comprises means for calibration of a reference position.

61. A control system according to claim 60, wherein said calibration of a reference position is predefined.

62. A control system according to claim 60, wherein said calibration of a reference position is performed automatically.

63. A control system according to claim 60, wherein said calibration of a reference position is performed manually.

64. A control system according to claim 60, wherein said calibration of a reference position is performed for an individual sensor.

65. A control system according to claim 26, wherein said calibration means comprises means for calibration of active range

66. A control system according to claim 65, wherein said calibration of an active range is predefined.

67. A control system according to claim 65, wherein said calibration of the active range is performed manually.

68. A control system according to claims 65, wherein said calibration of the active range is performed automatically.

69. A control system according to claim 1, wherein said control system further comprises means for automatic decision of which sensor to use.

70. A control system according to claim 34, wherein said motion detection sensors is permanently positioned on a wall.

71. Use of the control system of claim 1 in a rehabilitation system.

72. Use of the control system of claim 1 for data analysis system.

73. Use of the control system of claim 1 in a remote control system.

74. Use in a remote control system according to claim 73 for controlling an intelligent room.

75. Use of the control system of claim 1 for interactive entertainment.

76. Use for interactive entertainment according to claim 75, wherein said interactive entertainment comprises virtual reality interactivity.

77. Use of the control system of claim 1 for controlling three-dimensional models.

78. Use of the control system of claim 1 in learning systems.

79. Motion detector comprising a set of partial detectors of different types with respect to detection characteristics.

80. Motion detector according to claim 79, wherein the motion detector is adaptive.

81. Motion detector for use in a system according to claim 79.
